(19) United States
(12) Patent Application Publication
(10) Pub. No.: US 2022/0333901 A1
(43) Pub. Date: Oct. 20, 2022

(54) BALLISTIC PLATE OF BULLETPROOF JACKET THAT IMPROVES BULLETPROOF PERFORMANCE AND FLEXIBILITY, AND WEARABILITY

(71) Applicant: JONG OAK KIM, Seoul (KR)

(72) Inventor: JONG OAK KIM, Seoul (KR)

(21) Appl. No.: 17/673,787

(22) Filed: Feb. 17, 2022

(30) Foreign Application Priority Data
Feb. 23, 2021 (KR) 10-2021-0024116

(51) Int. Cl. F41H 5/04; B32B 5/02; B32B 27/12; B32B 27/30; B32B 27/40; B32B 5/26; B32B 27/32; B32B 27/08; A41D 31/24

(52) U.S. Cl. CPC F41H 5/0478; B32B 5/024; B32B 27/12; B32B 27/306; B32B 27/40; B32B 5/028; B32B 5/262; B32B 27/32; B32B 27/08; A41D 31/24; B32B 2571/02; B32B 2307/558; B32B 2307/306; B32B 2307/54; B32B 2262/0269; B32B 2307/51; B32B 2307/56

(57) ABSTRACT

A ballistic plate of a bulletproof jacket includes a bulletproof distribution pad and a shock-absorbing pad in which the bulletproof distribution pad is configured by sequentially arranging from the front a heatproof shock-absorbing sheet at the front, a heatproof distribution sheet having high heat resistance and distributing shock, and a bulletproof sheet absorbing and distributing shock; the shock-absorbing pad is configured by sequentially arranging from the front a first heatproof shock-absorbing sheet at the rear, a flex pelt absorbing shock, and a second heatproof shock-absorbing sheet at the rear; and the heatproof shock-absorbing sheets at the front and the rear are each formed by attaching a polyurethane-based resin film or a PVB film to one or more of the front surface and the rear surface of an aramid fabric woven such that aramid fabric threads are arranged to cross each other at right angles in a crossover pattern.

### BACKGROUND OF THE INVENTION

### Field of the Invention

The present disclosure relates to a ballistic plate of a bulletproof jacket and, more particularly to a ballistic plate of a bulletproof jacket that improves bulletproof performance, flexibility, and wearability, the ballistic plate being able to provide a high defense ability against a bullet by absorbing and distributing shock energy, being able to protect a body due to small deformation, being light, being able to improve wearability, and being able to reduce the manufacturing cost.

### Description of the Related Art

This part only provides background information about the present disclosure and is not necessarily a prior art.

In general, a bulletproof jacket that protects a body from firearms, splinters, explosives, or the like is composed of a garment, a panel & panel cover, and a plate.

The purpose of a ballistic plate that is a key part of a bulletproof jacket is to minimize an injury by stopping a projectile (speed “0”) that is a bullet from firearms by reducing the speed of the projectile.

The defense principle of a ballistic plate is as follows.

A bullet fired from a muzzle is in a high-temperature state due to friction with the air after firing. When the high-temperature bullet comes in contact with a ballistic plate, shock energy is generated and diffused around. Thereafter, the bullet that is traveling is blocked by the ballistic plate and stopped on the ballistic plate as it is gradually compressed.

Accordingly, a ballistic plate requires a characteristic of absorbing shock energy well and resisting high temperature well.

Further, when a projectile hits transversely against a fabric, two waves, that is, a longitudinal wave front and a transverse wave front spread from the hitting point, and in this case, it can be seen that the fabric is pushed backwards and changed in tension.

In a test of firing a bullet to a ballistic plate on a mud plate, it can be seen the ballistic plate deforms while applying shock energy to the mud plate due to propulsion of the bullet and then returns to the initial state. Accordingly, tensile strength should be sufficiently considered to prevent a negative influence on a body due to deformation of the ballistic plate even though the ballistic plate is not perforated by minimizing deformation of the ballistic plate due to shock energy.

As for the process in which a bullet is captured by a ballistic plate, a bullet fired from a firearm applies shock energy to a ballistic plate, the applied shock energy changes into heat energy while spreading like waves, so heat is generated. In this case, the bullet gradually stops at a temperature of 150° C. or more.

The mechanism that a bullet is stopped by a ballistic plate is that shock energy spreads while applying predetermined deformation to the ballistic plate, so the bullet speed gradually decreases, whereby the bullet is stopped.

A distribution mechanism of shock waves due to deformation of threads of a ballistic plate when the ballistic plate spreads shock energy while deforming is shown.

When the multi-layered threads of the ballistic plate deform, shock energy spreads away from the point of impact through the threads and energy decreases. This process is shown in the same way on multi-layered surfaces when a ballistic plate is composed of several layers.

Ballistic plates for protecting the wearer from bullets using this principle are manufactured under National Institute of Justice (NIJ) THREAT LEVEL (within 44 mm of back defense performance) that is the test standard for police bulletproof jacket of NIJ that is the most internationally officially approved.

A ballistic plate should satisfy the following conditions.

First, a defense ability against a bullet should be good and standards should be satisfied.

Second, deformation of a ballistic plate should be considered. That is, a ballistic plate is recognized as a ballistic plate with excellent performance only when backward deformation is small not to injure the inside of a body by minimizing shock even if a bullet is passed. It is prescribed that “a LEVEL IIIA protector of NIJ-STANDARD-0101.06 should have backward deformation of 44 mm or less without being perforated by a projectile such as a 0.44 magnum projectile at a prescribed speed (Vo) of 436 m/s+/−9 m/s (1430 ft/s)”.

Third, activity convenience should be secured through light-weighting and thinning in consideration of the weight and thickness.

Fourth, wearability should be good.

Fifth, the manufacturing cost should be low.

As a patent document from which the background of the present disclosure is found, there is Korean Patent No. 10-0629461, titled “Protect panel for ballistic attack”, which includes: a front plate having a plurality of sheets of aromatic polyamide-based fabrics sewn in diamond shapes on the surfaces; a flex pelt layer made of a shock-absorbing material composed of threads of a textile woven in a net shape with aromatic polyamide-based fabrics or high-density polyethylene-based fabrics, and cotton-shaped thin aromatic polyamide-based fabrics or high-density polyethylene-based fabrics forcibly fitted between the threads; and a rear plate composed of a plurality of sheets of aromatic polyamide-based fabrics that are sewn in box shapes on the surface, in which the front plates, the flex pelt layer, and the rear plate are sequentially bonded to improve bulletproof performance, flexibility, and wearability. Since the front plates are quilted in diamond shapes and the rear plates are quilted in box shapes, flexibility is poor. Accordingly, there is a defect that wearability is not good, which deteriorates activity convenience and combat power (defense ability). Further, the ability of absorbing and distributing shock energy is also deteriorated at the flex pelt layer between the front plates and the rear plates.

### CITATION LIST

### Patent Literature

Patent Literature 1: Korean Patent No. 10-0629461

### SUMMARY OF THE INVENTION

The present disclosure has been made in an effort to solve the problems described above, and an objective of the present disclosure is to provide a ballistic plate of a bulletproof jacket that improves bulletproof performance, flexibility, and wearability, the ballistic plate improving the defense ability against a bullet by absorbing and distributing shock energy, effectively protecting a body by reducing deformation due to heat and shock energy, providing improved wearability because there is no quilting, and reducing the manufacturing cost by decreasing the materials.

A ballistic plate of a bulletproof jacket that improves bulletproof performance, flexibility, and wearability according to the present disclosure is manufactured without quilting, has, as a solution principle of defense, primary defense of blocking a bullet and distributing and absorbing shock energy without deformation by high-temperature heat when it is hit by a bullet (including a splinter) and secondary defense of blocking a bullet, absorbing shock energy, and then protecting a wearer after the primary defense, and has, as a solution principle of activity convenience, not using quilting. The primary defense is made by a bulletproof distribution pad configured by sequentially arranging from the front a heatproof shock-absorbing sheet at the front, a heatproof distribution sheet having high heat resistance and distributing shock, and a bulletproof sheet absorbing and distributing shock; the secondary defense is made by a shock-absorbing pad configured by sequentially arranging from the front a first heatproof shock-absorbing sheet at the rear, a flex pelt absorbing shock, and a second heatproof shock-absorbing sheet at the rear; and the heatproof shock-absorbing sheets at the front and the rear are each composed of a fabric having high heat resistance and tensile strength and a polyurethane-based resin film or a PVB film (resin film added with PVB) contributing to improving the tensile strength of the fabric.

### BRIEF DESCRIPTION OF THE DRAWINGS

FIG. 1 is a view showing the configuration of a ballistic plate of a bulletproof jacket that improves bulletproof performance, flexibility, and wearability according to the present disclosure.

### DETAILED DESCRIPTION OF THE PREFERRED EMBODIMENTS

In the following description of the present disclosure, detailed descriptions of well-known functions or configurations relating to the disclosure will not be provided so as not to obscure the description of the disclosure with unnecessary details. Further, the following terminologies are defined in consideration of the functions in the present disclosure and may be construed in different ways by the intention or practice of users and operators. Therefore, the definitions thereof should be construed based on the contents throughout the specification.

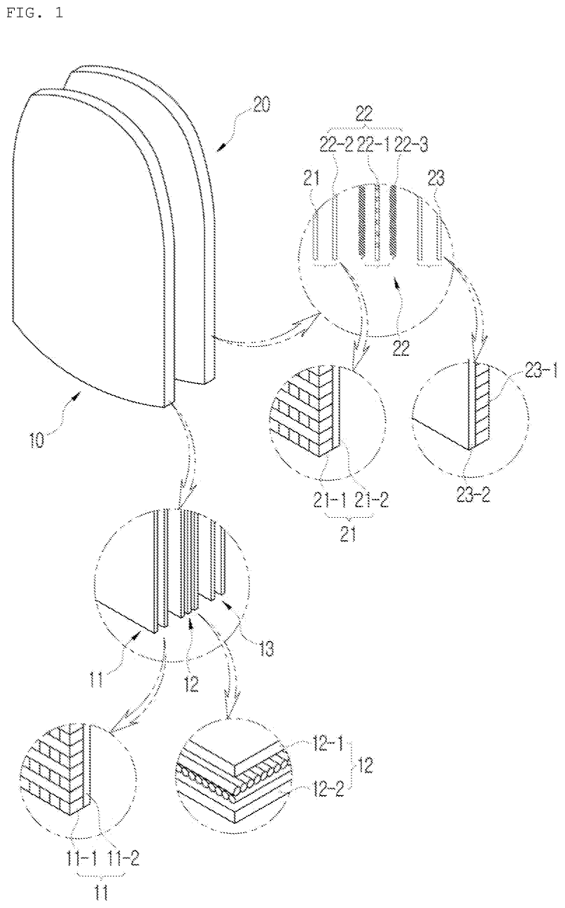

As shown in FIG. 1, the ballistic plate of a bulletproof jacket that improves bulletproof performance, flexibility, and wearability of the present disclosure includes a bulletproof distribution pad 10 and a shock-absorbing pad 20, in which the bulletproof distribution pad 10 is, for primary defense, composed of a heatproof shock-absorbing sheet 11, a heatproof distribution sheet 12, and a bulletproof sheet 13. The shock-absorbing pad 20 is, for secondary defense, composed of a first heatproof shock-absorbing sheet 21, a flex pelt 22, and a second heatproof shock-absorbing sheet 23. The detailed characteristics and stacking structure are as follows.

1. Bulletproof Distribution Pad 10

A. Heatproof Shock-Absorbing Sheet 11

The heatproof shock-absorbing sheet 11 blocks a bullet and absorbs shock while not being deformed by high-temperature heat, which is applied when it is hit by a bullet (including a splinter), and is preferably made of an aramid fabric 11-1 and a polyurethane-based resin film or a PVB film 11-2.

The aramid fabric 11-1 is woven by arranging aramid threads in the direction of weft and warp threads in a crossover pattern and has excellent tensile strength and weaving characteristics, so the wefts and warp threads are not open and maintained in the woven state. Accordingly, the aramid fabric 11-1 reduces the speed of a bullet and does not deform by the heat of the bullet, thereby effectively blocking a bullet without cutting or stretching.

The PVB film 11-2 uses polyvinyl butyral (a resin film added with PVB) and is known as being tough and hard and having an excellent shock-absorbing ability. Further, the PVB film 11-2 is attached to the rear surface of the aramid fabric 11-1 in the bulletproof distribution pad 10 (by temperature and pressure or by an adhesive), because when the aramid fabric 11-1 is attached to the front surface, it may be deformed by the heat of a bullet and consequently it cannot perform its function.

One or more, preferably, two to four sheets of heatproof shock-absorbing sheets 11 having this configuration is used, and more preferably, two sheets are stacked and used.

The polyurethane-based resin film is a product having excellent tensile strength and heat resistance.

B. Heatproof Distribution Sheet 12

The heatproof distribution sheet 12, which is a unidirectional flex composed of aramid threads 12-1 stacked in the direction of unidirectional weft and warp threads and a coating layer 12-2 coated with polyester-based resin on both a top and a bottom, is provided to attenuate the shock energy absorbed by the heatproof shock-absorbing sheet 11, and particularly, distributes shock energy widely and linearly along the wefts and warp threads using the structural characteristics.

Two or more, preferably, two to five sheets of heatproof distribution sheets 12 are used, and three sheets are used for two sheets of heatproof shock-absorbing sheets 11.

C. Bulletproof Sheet 13

The bulletproof sheet 13, which defends by absorbing shock energy by a bullet, absorbs and distributes shock energy distributed by the heatproof distribution sheet 12, is preferably made of a polyethylene (or high-density polyethylene) film that absorbs and distributes shock energy using excellent tension, in which 5 to 30 sheets are preferable, and 17 sheets are stacked and used for two heatproof shock-absorbing sheets 11 and three heatproof distribution sheets 12.

17 sheets of polyethylene films absorb and distribute shock energy through multiple steps, thereby minimizing the shock energy that is transmitted to the shock-absorbing pad 20.

2. Shock-Absorbing Pad 20

A. First Heatproof Shock-Absorbing Sheet 21 and Second Heatproof Shock-Absorbing Sheet 23

The first heatproof shock-absorbing sheet 21 and the second heatproof shock-absorbing sheet 23 are, same as the heatproof shock-absorbing sheet 11 of the bulletproof distribution pad 10, are composed of aramid fabrics 21-1 and 23-1 and polyurethane-based resin films or PVB films 21-2 and 23-2, respectively. However, the polyurethane-based resin film or the PVB film 21-2 is attached to the rear surface of the aramid fabric 21-2 in the first heatproof shock-absorbing sheet 21, and the polyurethane-based resin film or the PVB film 23-2 is attached to front surface of the aramid fabric 23-1 in the second heatproof shock-absorbing sheet 23. Accordingly, the flat resin films 21-2 and 23-2 attached to the aramid fabrics maximize absorption of shock energy by sealing the flex pelt 22 at the front and rear surfaces, thereby improving the bullet defense effect.

The numbers of the first heatproof shock-absorbing sheet 21 and the second heatproof shock-absorbing sheet 23 are the same as the number of the heatproof shock-absorbing sheet 11 of the bulletproof distribution pad 10.

B. Flex Pelt 22

The flex pelt 22 is made of an aramid reinforcement net 22-1 and aramid pelts 22-2 and 23-2 covering the front and rear surfaces of the aramid reinforcement net 22-1. The aramid pelts 22-2 and 23-2 are attached to be forcibly fitted in holes of the aramid reinforcement net 22-1 to be integrated with the reinforcement net 22-1, whereby they absorb shock energy at the front and rear while having tension, that is, while maintaining the shape, thereby minimizing shock energy that is transmitted to the wearer.

Only one sheet of flex pelt 22 may be enough to absorb shock, and two sheets may be used, depending on cases.

The ballistic plate of a bulletproof jacket that improves bulletproof performance, flexibility, and wearability which has the stacking structure described above is inserted inside a separate garment and then the garment is sewn to be used. Further, the ballistic plate is inserted in a bulletproof jacket to be replaceable.

Meanwhile, the shock-absorbing pad 20, which may also be called a trauma pad, is not necessarily used with the bulletproof distribution pad 10, that is, may be individually used or may be used with the bulletproof distribution pad 10 and other products to absorb shock energy that is transmitted to the wearer. When the shock-absorbing pad 20 is individually used, for example, it absorbs shock energy that is transmitted to a hard armor (a bulletproof insertion, plate) from behind (from the wearer side) of the hard armor. Of course, the bulletproof distribution pad 10 may also be used individually or with the shock-absorbing pad 20 and other products. The hard armor has been disclosed, for example, in Korean Patent No. 10-1713647.

The defense system of the ballistic plate of a bulletproof jacket that improves bulletproof performance, flexibility, and wearability according to the present disclosure is as follows.

1. Shock Energy Absorption and Heat Resistance

When a bullet (including a splinter of an explosive) hits against the heatproof shock-absorbing sheet 10, the aramid fabric 11-1 first absorbs heat by the stacking structure and blocks the bullet using strong tension. Further, the PVB film 11-1 that is the next layer absorbs shock energy, which is transmitted from the aramid fabric 11-1, using tension and prevents the bullet from further traveling.

2. Shock Energy Distribution

A bullet applies shock energy to the heatproof distribution sheet 12 while perforating the heatproof shock-absorbing sheet 10 or pushing the heatproof shock-absorbing sheet 10, and the heatproof distribution sheet prevents heat, which is transmitted through the heatproof shock-absorbing sheet 11, from traveling by absorbing the heat using heat resistance and tension of the aramid thread 12-1. In particular, since the aramid threads 12-1 are arranged in one direction, shock energy is widely transmitted up to portions that are far away from the hitting point along the lines of the aramid threads 12-1, whereby shock energy that is applied to the wearer is greatly decreased.

3. Shock Energy Reduction

Shock energy by a bullet is transmitted to the bulletproof sheet 13 through the heatproof distribution sheet 12 and the polyethylene film layer of the bulletproof sheet 13 blocks the bullet from traveling by reducing the shock energy using tension. Since heat of the splinter decreases through the heatproof shock-absorbing sheet and the heatproof distribution sheet 12, so the polyethylene film layer securely blocks the bullet from traveling using tension without thermal deformation, and absorbs and distributes shock from the splinter in this process.

4. Shock Energy Absorption and Heat Resistance

Shock energy by a bullet that travels forward while pushing the bulletproof sheet 13 is transmitted to the first heatproof shock-absorbing sheet 21 of the shock-absorbing pad 20, the aramid fabric 21-1 blocks the bullet using strong tension while first absorbing heat, and the PVB film 21-2 that is the next layer blocks the bullet from traveling while absorbing shock energy transmitted from the aramid fabric 11-1 using tension.

5. Shock Energy Absorption

The flex pelt 22 absorbs and distributes shock energy of a bullet traveling to the bulletproof sheet 13, in more detail, the aramid pelts 22-2 and 22-3 of the flex pelt 22 absorbs shock energy not absorbed in the previous layers. In this process, the aramid reinforcement net 22-1 prevents the aramid pelts 22-2 and 22-3 from being pushed backwards and from being perforated, and particularly, keeps the point hit by the splinter tensed not to contract, thereby maintaining the defense area of the ballistic plate same before and after hitting. Accordingly, it is possible to also defend following splinters.

6. Shock Energy Absorption and Heat Resistance

The shock energy by the bullet that travels while pushing the flex pelt 22 is finally transmitted to the second heatproof shock-absorbing sheet 23, the aramid fabric 23-1 cools heat, and the PVB film 23-2 absorbs the shock energy using a shock-absorbing ability.

The ballistic plate of a bulletproof jacket that improves bulletproof performance, flexibility, and wearability according to the present disclosure can protect a body by using a defense ability and reducing deformation through a primary defense system that absorbs and distributes shock energy using excellent heat resistance and tension of the heatproof shock-absorbing sheet and a secondary defense system that absorbs and distributes shock energy. Further, since the materials are reduced, and the thickness and weight are decreased, in comparison to existing ballistic plates, there is an effect of improving wearability and reducing the manufacturing cost. Further, since the weight is reduced and quilting is not used in the manufacturing process, there is an effect of improving activity convenience and combat power.

While the present invention has been described with respect to the specific embodiments, it will be apparent to those skilled in the art that various changes and modifications may be made without departing from the spirit and scope of the invention as defined in the following claims.

What is claimed is:

1. A ballistic plate of a bulletproof jacket that improves bulletproof performance, flexibility, and wearability, comprising a bulletproof distribution pad and a shock-absorbing pad that are manufactured without quilting,
wherein the bulletproof distribution pad is configured by sequentially arranging from the front a heatproof shock-absorbing sheet at the front, a heatproof distribution sheet having high heat resistance and distributing shock, and a bulletproof sheet absorbing and distributing shock,
the shock-absorbing pad is configured by sequentially arranging from the front a first heatproof shock-absorbing sheet at the rear, a flex pelt absorbing shock, and a second heatproof shock-absorbing sheet at the rear, and
the heatproof shock-absorbing sheets at the front and the rear are each composed of a fabric having high heat resistance and tensile strength and a polyurethane-based resin film or a PVB film contributing to improving the tensile strength of the fabric and absorbing shock.

2. The ballistic plate of claim 1, wherein the heatproof shock-absorbing sheet is formed by attaching a polyurethane-based resin film or a PVB film to one or more of the front surface and the rear surface of an aramid fabric woven such that aramid fabric threads are arranged to cross each other at right angles in a crossover pattern.

3. The ballistic plate of claim 2, wherein the polyurethane-based resin film or the PVB film is attached to the rear surface of the aramid fabric in the heatproof shock-absorbing sheet at the front, the polyurethane-based resin film or the PVB film is attached to the rear surface of the first heatproof shock-absorbing sheet at the rear, and the polyurethane-based resin film or the PVB film is attached to the front surface of the second heatproof shock-absorbing sheet.

4. The ballistic plate of claim 1, wherein the flex pelt is composed of an aramid reinforcement net in a net shape having several holes and aramid pelts covering the front and rear surfaces of the aramid reinforcement net.

5. The ballistic plate of claim 1, wherein the heatproof distribution sheet is an aramid film and the bulletproof sheet is a polyethylene film or an aramid film.

6. The ballistic plate of claim 5, wherein the bulletproof distribution pad has a layered structure composed of one or more heatproof shock-absorbing sheets at the front, two or more heatproof distribution sheets, and five or more polyethylene film bulletproof sheets; and
the shock-absorbing pad has a layered structure composed of one or more first heatproof shock-absorbing sheets at the rear, one or more sheets of flex pelts, and one or more second heatproof shock-absorbing sheets at the rear.

7. A ballistic plate of a bulletproof jacket that improves bulletproof performance, flexibility, and wearability, comprising a trauma pad configured by sequentially arranging from the front a first heatproof shock-absorbing sheet, a flex pelt absorbing shock, and a second heatproof shock-absorbing sheet at the rear, and
wherein the first and second heatproof shock-absorbing sheets are each composed of a fabric having high heat resistance and tensile strength and a polyurethane-based resin film or a PVB film contributing to improving the tensile strength of the fabric and absorbing shock.

8. The ballistic plate of claim 7, wherein the trauma pad is disposed toward a wearer of the front and the rear of a hard armor and absorbs shock energy that is transmitted from the hard armor.

9. A ballistic plate of a bulletproof jacket that improves bulletproof performance, flexibility, and wearability, comprising a bulletproof distribution pad configured by sequentially arranging from the front a heatproof shock-absorbing sheet at the front, a heatproof distribution sheet having high heat resistance and distributing shock, and a bulletproof sheet absorbing and distributing heat.
